(19) United States
(12) Patent Application Publication
(10) Pub. No.: US 2010/0060903 A1
(43) Pub. Date: Mar. 11, 2010

(54) Image Measuring Apparatus and Computer Program

(75) Inventors: Takashi Nakatsukasa, Osaka (JP); Takashi Naruse, Osaka (JP)

Correspondence Address: KILYK & BOWERSOX, P.L.L.C., 400 HOLIDAY COURT, SUITE 102, WARRENTON, VA, 20186, US

(73) Assignee: Keyence Corporation, Osaka (JP)

(21) Appl. No.: 12/537,290

(22) Filed: Aug. 7, 2009

(30) Foreign Application Priority Data
Sep. 8, 2008 (JP) 2008-229201

(51) Int. Cl. G01B 11/24

(52) U.S. Cl. 356/601; 382/224

(57) ABSTRACT

A shape of a measurement object is measured based on an image obtained by applying light onto a stage having the measurement object mounted thereon and performing image formation of transmitted light or reflected light of the light on an imaging device. An image of the measurement object that is obtained by image formation on an imaging device is displayed within the range of the field of view, and feature quantity information is extracted based on the image of the measurement object. A determination is made as to whether feature quantity information approximately in agreement with the extracted feature quantity information is stored. If it is determined that the feature quantity information approximately in agreement with the extracted feature quantity information is stored, then the shape of the measurement object is measured based on information on measurement conditions stored in association with the feature quantity information.

### CROSS-REFERENCE TO RELATED APPLICATIONS

The present application claims foreign priority based on Japanese Patent Application No. 2008-229201, filed Sep. 8, 2008, the contents of which is incorporated herein by reference.

### BACKGROUND OF THE INVENTION

1. Field of the Invention

The present invention relates to an image measuring apparatus and a computer program for measuring a desired shape based on feature quantity information inherent in the shape of a measurement object. In particular, the present invention relates to an image measuring apparatus and a computer program that can easily specify measurement conditions for a measurement object when the measurement object is known.

2. Description of the Related Art

As an apparatus for measuring a shape of a measurement object, a number of image measuring apparatuses have been developed. Such an image apparatus applies light to a measurement object mounted on a stage, acquires an image by image formation of transmitted light or reflected light of the applied light on an imaging device, such as a CCD (charge coupled device) and CMOS (complementary metal-oxide semiconductor), through a light receiving lens, and measures the shape of the measurement object based on the acquired image.

The measurement of the shape of a measurement object is performed by detecting a boundary portion (hereinafter referred to as an “edge portion”) between the measurement object and the background image on an image. The edge portion is a part with a sharp change in luminance value between the pixel of a measurement object and the pixel of a background image. For example, a part (between pixels) with a luminance difference between adjacent pixels larger than a predetermined value in image data is acquired as a plurality of edge points representing an edge portion. A shape formed by connecting the acquired edge points is approximated to a geometrical figure, such as a line or a circle, by using a regression analysis method, such as a method of least squares. By using this figure, a distance and an angle between edges, and parameters (coordinates, diameter, central coordinate and the like) of the edges themselves can be measured.

If measurement objects having the same shape are measured many times, a desired shape may be measured by storing a shape pattern once measured and performing pattern matching using the stored shape pattern so as to reduce a load of computing caused by extracting edges every time. For example, in Japanese Patent No. 3596753, pattern matching with an image of a measurement object is performed using image data generated by off-line teaching, so that the shape is measured.

The process of pattern matching with an image of a measurement object, however, requires a relatively large load of computing. As the number of kinds of the measurement objects increases, the number of shape pattern image data to be stored increases. This puts pressure on the storage capacity of a memory and the like and increases the entire load of computing. Therefore, there is a problem that keeping a measurement response is difficult.

On the other hand, there are feature quantities inherent in a shape of a measurement object in the image obtained by imaging the measurement object. For example, there are a number of feature quantities inherent in the shape of the obtained image, such as an area, a surrounding length, and a distance from a center of gravity to a border line of the obtained image. Accordingly, if measurement conditions are stored based on feature quantity information on such feature quantities, the shape can be reliably measured with a smaller load of computing.

### SUMMARY OF THE INVENTION

In view of such circumstances, an object of the present invention is to provide an image measuring apparatus and a computer program that can specify measurement conditions based on feature quantity information inherent in an image obtained by imaging a measurement object.

In order to achieve the above-described object, according to a first aspect of the present invention, there is provided an image measuring apparatus for measuring a shape of a measurement object based on an image obtained by applying light onto a stage having the measurement object mounted thereon and performing image formation of transmitted light or reflected light of the light on an imaging device, the image measuring apparatus including: a feature quantity information storing unit configured to store feature quantity information inherent in the shape of the measurement object in association with information on measurement conditions of the measurement object; a displaying unit configured to display, within a range of a field of view, the image of the measurement object obtained by performing image formation on the imaging device; a feature quantity information extracting unit configured to extract feature quantity information based on the image of the measurement object; a determining unit configured to determine whether feature quantity information approximately in agreement with the extracted feature quantity information is stored; and a measuring unit configured to measure the shape of the measurement object if it is determined in the determining unit that the feature quantity information approximately in agreement is stored, based on the information on the measurement conditions stored in association with the feature quantity information.

According to a second aspect of the present invention, the image measuring apparatus according to the first aspect further includes: an image presence determining unit configured to determine whether the image of the measurement object is in a periphery of the field of view, if it is determined in the determining unit that the feature quantity information approximately in agreement is not stored; and a message outputting unit configured to output and display a message to move the measurement object so that the measurement object is within the range of the field of view, if it is determined in the image presence determining unit that the image of the measurement object is in the periphery of the field of view.

According to a third aspect of the present invention, in the image measuring apparatus according to the second aspect, the message outputting unit is configured to output and display a message to confirm a direction in which the measurement object is mounted, if it is determined in the image presence determining unit that the image of the measurement object is not in the periphery of the field of view.

According to a fourth aspect of the present invention, the image measuring apparatus according to any one of the first to third aspects further includes: a shape pattern image storing unit configured to store shape pattern image data of the measurement object in association with the information on the measurement conditions of the measurement object; a displaying unit configured to display, if it is determined in the determining unit that a plurality of pieces of the feature quantity information approximately in agreement are stored, information corresponding to a plurality of pieces of corresponding shape pattern image data; and a selection receiving unit configured to receive selection of information corresponding to one piece of shape pattern image data from the information corresponding to the plurality of pieces of displayed shape pattern image data.

According to a fifth aspect of the present invention, the image measuring apparatus according to any one of the first to third aspects further includes: a reextracting unit configured to extract another feature quantity information if it is determined in the determining unit that a plurality of pieces of the feature quantity information approximately in agreement are stored, based on the same image of the measurement object; and a redetermining unit configured to determine, for information on measurement conditions corresponding to the plurality of pieces of the stored feature quantity information, whether feature quantity information approximately in agreement with the another feature quantity information extracted by the reextracting unit is stored; and wherein the measuring unit is configured to measure the shape of the measurement object if it is determined in the redetermining unit that the feature quantity information approximately in agreement with the another feature quantity information is stored, based on the information on the measurement conditions stored in association with the feature quantity information.

In order to achieve the above-mentioned object, according to a sixth aspect of the present invention, there is provided a computer program executable with an image measuring apparatus for measuring a shape of a measurement object based on an image obtained by applying light onto a stage having the measurement object mounted thereon and performing image formation of transmitted light or reflected light of the light on an imaging device, the computer program causing a computer to realize a function of the image measuring apparatus, the image measuring apparatus including: a feature quantity information storing unit configured to store feature quantity information inherent in the shape of the measurement object in association with information on measurement conditions of the measurement object; a displaying unit configured to display, within a range of a field of view, the image of the measurement object obtained by performing image formation on the imaging device; a feature quantity information extracting unit configured to extract feature quantity information based on the image of the measurement object; a determining unit configured to determine whether feature quantity information approximately in agreement with the extracted feature quantity information is stored; and a measuring unit configured to measure the shape of the measurement object if it is determined in the determining unit that the feature quantity information approximately in agreement is stored, based on the information on the measurement conditions stored in association with the feature quantity information.

According to a seventh aspect of the present invention, in the computer program according to the sixth aspect, the image measuring apparatus further includes: an image presence determining unit configured to determine whether the image of the measurement object is in a periphery of the field of view, if it is determined in the determining unit that the feature quantity information approximately in agreement is not stored; and a message outputting unit configured to output and display a message to move the measurement object so that the measurement object is within the range of the field of view, if it is determined in the image presence determining unit that the image of the measurement object is in the periphery of the field of view.

According to an eighth aspect of the present invention, in the computer program according to the seventh aspect, the message outputting unit is configured to output and display a message to confirm a direction in which the measurement object is mounted, if it is determined in the image presence determining unit that the image of the measurement object is not in the periphery of the field of view.

According to a ninth aspect of the present invention, in the computer program according to any one of the sixth to eighth aspects, the image measuring apparatus further includes: a shape pattern image storing unit configured to store shape pattern image data of the measurement object in association with the information on the measurement conditions of the measurement object; a displaying unit configured to display, if it is determined in the determining unit that a plurality of pieces of the feature quantity information approximately in agreement are stored, information corresponding to a plurality of pieces of corresponding shape pattern image data; and a selection receiving unit configured to receive selection of information corresponding to one piece of shape pattern image data from the information corresponding to the plurality of pieces of displayed shape pattern image data.

According to a tenth aspect of the present invention, in the computer program according to any one of the sixth to eighth aspects, the image measuring apparatus further includes: a reextracting unit configured to extract another feature quantity information if it is determined in the determining unit that a plurality of pieces of the feature quantity information approximately in agreement are stored, based on the same image of the measurement object; and a redetermining unit configured to determine, for information on measurement conditions corresponding to the plurality of pieces of the stored feature quantity information, whether feature quantity information approximately in agreement with the another feature quantity information extracted by the reextracting unit is stored; and wherein the measuring unit is configured to measure the shape of the measurement object if it is determined in the redetermining unit that the feature quantity information approximately in agreement with the another feature quantity information is stored, based on the information on the measurement conditions stored in association with the feature quantity information.

According to the first and sixth aspects of the present invention, feature quantity information inherent in the shape of a measurement object is stored in association with information on measurement conditions of the measurement object. An image of the measurement object that is obtained by image formation on an imaging device is displayed within the range of the field of view, and feature quantity information is extracted based on the image of the measurement object. Examples of the feature quantity information include the area, the surrounding length, and the distance from the center of gravity to the border line of the obtained image, and the term “feature quantity information” means information of numerical values and the like that is inherent in the shape of the image obtained by imaging. If feature quantity information approximately in agreement with the extracted feature quantity information is stored, the shape of the measurement object is measured based on information on measurement conditions stored in association with the feature quantity information. Without a pattern matching process involving a large computing load between images, the shape of the image of the measurement object is measured based on information on measurement conditions associated with the feature quantity information that approximately agrees with the extracted feature quantity information. The feature quantity information is inherent in the shape of the image. Thus, the computing load can be greatly reduced.

In the second and seventh aspects of the present invention, if the feature quantity information approximately in agreement with the extracted feature quantity information is not stored, it may be determined whether the image of the measurement object is in the periphery of the field of view. If the image of the measurement object is in the periphery of the field of view, a message to move the measurement object so that the measurement object is within the range of the field of view may be outputted and displayed. Determination is made as to whether the image of the measurement object is in the periphery of the field of view, and if it is determined that the image is in the periphery, the measurement object can be considered to be mounted protruding from the field of view. Accordingly, by outputting a message notifying that effect, a measurement operator can be prompted to mount the measurement object again in a proper way. This makes it possible to measure the shape of the measurement object efficiently without recurring of the procedure, and the like.

In the third and eighth aspects of the present invention, if it is determined that the image of the measurement object is not in the periphery of the field of view, then a message to confirm a direction in which the measurement object is mounted may be outputted and displayed. If it is determined that the image of the measurement object is not in the periphery of the field of view, then the measurement object is not mounted protruding from the field of view. Possibilities of human errors that a measurement operator mounted a measurement by mistake, and that a measurement object is not mounted in a direction along which it should be mounted can be considered. Therefore, by outputting a message notifying that effect, a measurement operator can be prompted to mount the proper measurement object again in a proper way. This makes it possible to measure the shape of a measurement object efficiently without recurring of the procedure, and the like.

In the fourth and ninth aspects of the present invention, shape pattern image data of the measurement object in association with the information on the measurement conditions of the measurement object may be stored. If a plurality of pieces of feature quantity information approximately in agreement with the extracted feature quantity information are stored, information corresponding to a plurality of pieces of corresponding shape pattern image data may be displayed. Selection of information corresponding to one piece of shape pattern image data from the information corresponding to the plurality of pieces of displayed shape pattern image data may be received. Thus, it is possible to uniquely specify information on measurement conditions.

In the fifth and tenth aspects of the present invention, if a plurality of pieces of the feature quantity information approximately in agreement with the extracted feature quantity information is stored, another feature quantity information may be extracted based on the same image of the measurement object. Then, for information on measurement conditions corresponding to the plurality of pieces of stored feature quantity information, determination may be made as to whether feature quantity information approximately in agreement with the extracted another feature quantity information is stored. If it is determined that the feature quantity information approximately in agreement with the another feature quantity information is stored, then the shape of the measurement object may be measured based on the information on the measurement conditions stored in association with the feature quantity information. Narrowing down information on measurement conditions by using different pieces of feature quantity information for the same measurement object allows information on measurement conditions corresponding to the measurement object to be reliably narrowed down even when the information on measurement conditions cannot be narrowed down by using one feature quantity information only. This enables the shape to be accurately measured.

With the configuration mentioned above, the shape of the image of the measurement object is measured based on information on measurement conditions associated with feature quantity information that approximately agrees with the extracted feature quantity information, without a pattern matching process involving a large computing load between images. The feature quantity information is inherent in the shape of the image. Thus, the computing load can be greatly reduced. Also, even when it is impossible to narrow down information on measurement conditions by using one feature quantity information only, the information on measurement conditions corresponding to the measurement object can be reliably narrowed down by receiving selection of one piece of feature quantity information from a plurality of pieces of feature quantity information approximately in agreement with the extracted feature quantity information or specifying information on measurement conditions by using different pieces of feature quantity information. This enables the shape to be accurately measured.

### BRIEF DESCRIPTION OF THE DRAWINGS

FIG. 1 is a schematic view showing a configuration of an image measuring apparatus according to a first embodiment of the present invention;

FIG. 2 is a block diagram showing a configuration of a control unit of the image measuring apparatus according to the first embodiment of the present invention;

FIGS. 3A to 3F are schematic views showing kinds of feature quantity information according to the first embodiment;

FIG. 4 shows an example of a state where an image of a measurement object is placed across a boundary of a field of view;

FIG. 5 is a flow chart showing a procedure of a comparison process of feature quantity information of a CPU of a control unit of the image measuring apparatus according to the first embodiment of the present invention;

FIG. 6 is a flow chart showing a procedure of a subsequent process of the CPU of the control unit of the image measuring apparatus according to the first embodiment of the present invention, when feature quantity information approximately in agreement with extracted feature quantity information is not stored;

FIGS. 7A to 7D are views showing examples of false calculation of agreement caused by a difference in direction in which the measurement object is mounted;

FIG. 8 is a block diagram showing a configuration of a control unit of an image measuring apparatus according to a second embodiment of the present invention;

FIG. 9 is a flow chart showing a procedure of a comparison process of feature quantity information of a CPU of the control unit of the image measuring apparatus according to the second embodiment of the present invention;

FIG. 10 is a block diagram showing a configuration of a control unit of an image measuring apparatus according to a third embodiment of the present invention; and

FIG. 11 is a flow chart showing a procedure of a comparison process of feature quantity information of a CPU of the control unit of the image measuring apparatus according to the third embodiment of the present invention.

### DETAILED DESCRIPTION OF THE PREFERRED EMBODIMENTS

An image measuring apparatus according to an embodiment of the present invention will be described in detail below with reference to the accompanying drawings.

### First Embodiment

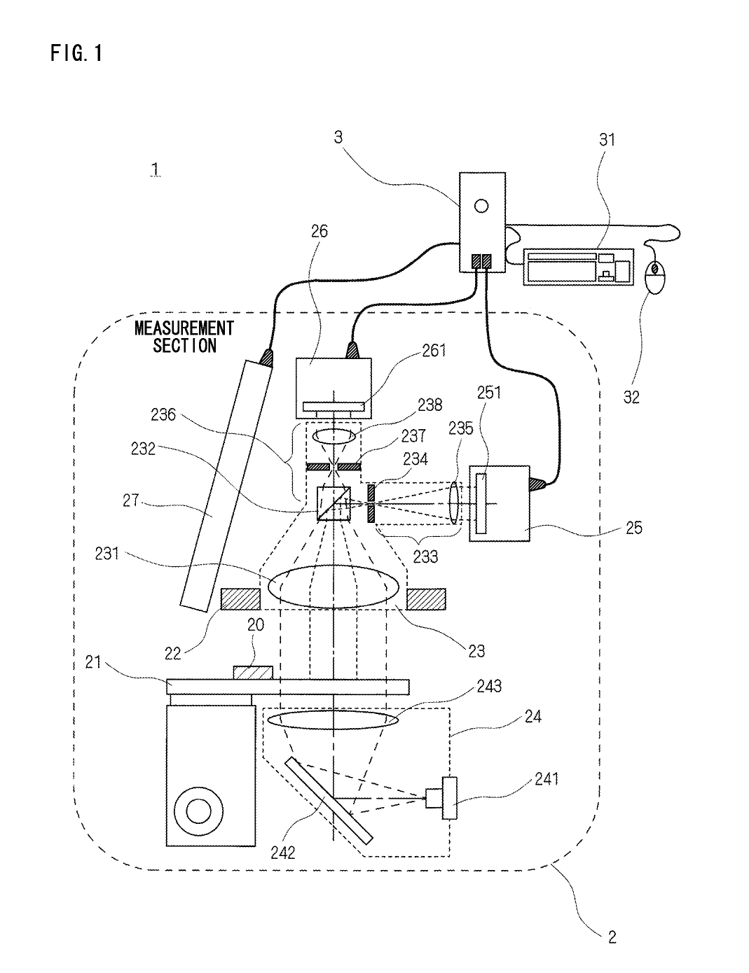

FIG. 1 is a schematic view showing a configuration of an image measuring apparatus according to a first embodiment of the present invention. As shown in FIG. 1, an image measuring apparatus 1 according to the first embodiment includes a measurement section 2 and a control unit 3. Image data is obtained by imaging in the measurement section 2, and computing is performed for the obtained image data in the control unit 3, so that sizes and the like of a desired shape are measured.

In the measurement section 2, two sets of lighting systems are disposed on either side of a stage 21 for moving a measurement object 20 to a measurement area. A ring-shaped epi-illuminating system 22, which illuminates the measurement object 20 of the stage 21 from the above, is provided in a light receiving lens unit 23. Light applied by the epi-illuminating system 22 is reflected from the surface of the measurement object 20, and is returned to the light receiving lens unit 23. In this manner, irregularities, a pattern and the like of the surface of the measurement object 20 can be imaged.

A transmission illuminating system 24, which illuminates the measurement object 20 from the below, is disposed under the stage 21. The transmission illuminating system 24 includes at least a light source 241, a reflecting mechanism 242 and a lens 243. Light applied from the light source 241 is reflected from the reflecting mechanism 242 toward the stage 21. Through the lens 243, the light is converted into parallel light rays in a direction approximately perpendicular to the stage 21. In this way, it is possible to perform imaging in which light is transmitted only through a position without the measurement object 20.

The light receiving lens unit 23 includes at least a light receiving lens 231, a beam splitter 232, a high-magnification-side image formation lens part 233 and a low-magnification-side image formation lens part 236. The high-magnification-side image formation lens part 233 includes a slit 234 for image formation and a high-magnification-side image formation lens 235, and the low-magnification-side image formation lens part 236 includes a slit 237 for image formation and a low-magnification-side image formation lens 238. The beam splitter 232 is a prism to cause light from the light receiving lens 231 to branch in two directions. For example, cubic-type and plate-type beam splitters may be used. Light passing through a cubic-type beam splitter is never refracted, and therefore the optical axis does not deviate and alignment adjustment of a branch angle is easy. Thus, a cubic-type beam splitter is preferable compared to a plate-type beam splitter.

FIG. 1 shows an example in which light emitted from the epi-illuminating system 22 guides light reflected from the measurement object 20 and light emitted from the transmission illuminating system 24 and transmitted through the measurement object 20 to the high-magnification-side image formation lens part 233 and the low-magnification-side image formation lens part 236. Light rays in two directions obtained by branching by the beam splitter 232 are guided to both the low-magnification-side image formation lens part 236 and the high-magnification-side image formation lens part 233.

The high-magnification-side imaging apparatus 25 performs image formation of light guided to the high-magnification-side image formation lens part 233 using the imaging device 251, such as a CCD or CMOS, and transmits the resultant image as high magnification image data to the control unit 3. Likewise, a low-magnification-side imaging apparatus 26 performs image formation of light guided to the low-magnification-side image formation lens part 236 using an imaging device 261, such as a CCD or CMOS, and transmits the resultant image as low magnification image data to the control unit 3. With the above configuration of two-branch optical system using the light receiving lens 231 and the beam splitter 232, high magnification image data and low magnification image data can be simultaneously acquired without mechanically switching the optical system. Both high and low image data can be electronically switched and displayed on one screen, and can be individually displayed simultaneously on two screens.

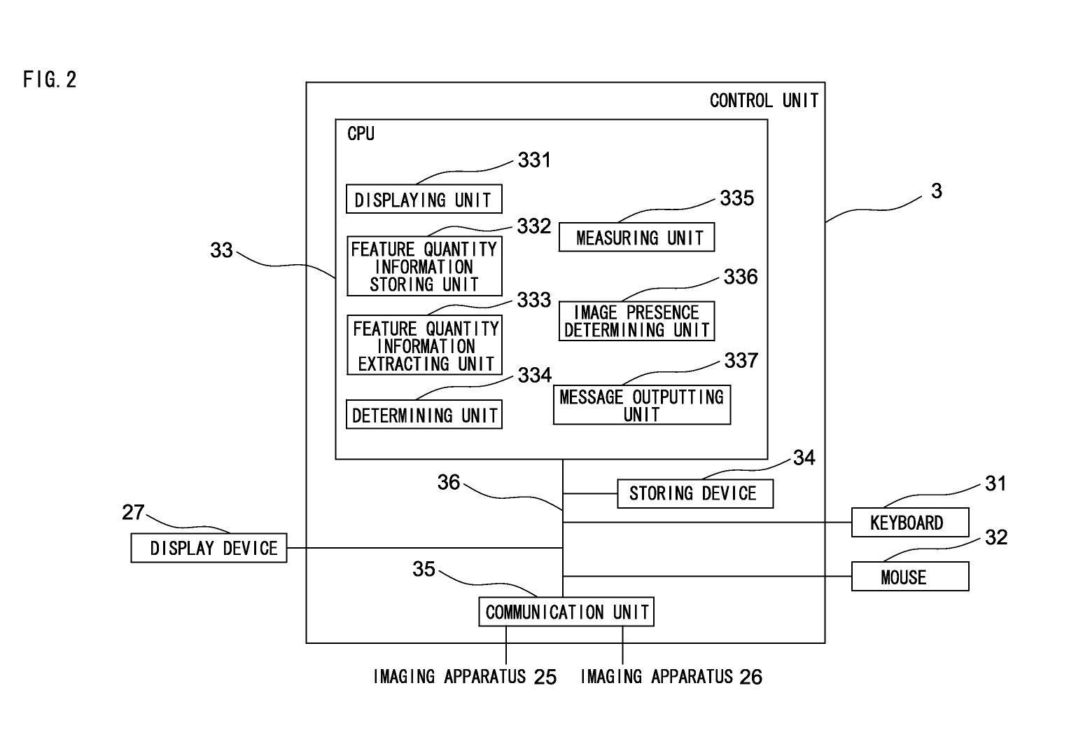

FIG. 2 is a block diagram showing the configuration of the control unit 3 of the image measuring apparatus 1 according to the first embodiment of the present invention. As shown in FIG. 2, the control unit 3 of the image measuring apparatus 1 according to the first embodiment includes at least a CPU (central processing unit) 33, a storing device 34, such as a memory, a communication unit 35, and an internal bus 36 that connects the hardware mentioned above. Through the internal bus 36, the control unit 3 is connected to a mouse 32 and a keyboard 31, which are input devices, and a display device 27, which is an output device.

The CPU 33 is connected through the internal bus 36 to units and parts of hardware of the control unit 3 as described above, and controls the operation of the units and parts of hardware and executes various software functions in accordance with computer programs stored in the storing device 34. The storing device 34 is of a volatile memory, such as an SRAM (static random access memory) or an SDRAM (synchronous dynamic random access memory), and a load module is expanded during execution of a computer program to store temporary data and the like generated during execution of the computer program. The feature quantity information inherent in the shape of the measurement object is also stored in the storing device 34.

The communication unit 35 is connected to the internal bus 36, and is connected through communication lines to imaging apparatuses 25 and 26 to receive image data obtained by image formation on the imaging apparatuses 25 and 26. By establishing connection to external networks, such as the Internet, LAN (local area network) and WAN (wide area network), data can be sent and received to and from the external networks or the like. Computer programs stored in the storing device 34 are downloaded from an external computer through the communication unit 35.

The CPU 33 of the control unit 3 functions as a displaying unit 331 for displaying epi-illumination image data, which is image data representing an epi-illumination image taken by the imaging apparatus 25 using the epi-illuminating system 22, and transmitted image data, which is image data representing a transmitted image taken by the imaging apparatus 26 using the transmission illuminating system 24, on the display device 27, and also as a feature quantity information storing unit 332 for storing, in the storing device 34, feature quantity information inherent in the shape of a measurement object, such as the area, the surrounding length, and the distance from the center of gravity to the border line of the obtained image. The CPU 33 also functions as a feature quantity information extracting unit 333 to extract one feature quantity information from an image obtained by imaging the measurement object 20, and as a determining unit 334 to determine whether feature quantity information approximately in agreement with the extracted feature quantity information is stored. The CPU 33 further functions as a measuring unit 335. If it is determined in the determining unit 334 that the feature quantity information, which approximately agrees with the extracted feature quantity information, is stored, the measuring unit 335 measures the shape of the measurement object based on information on measurement conditions stored in association with the feature quantity information.

Further, the CPU 33 functions as an image presence determining unit 336 and as a message outputting unit 337. If it is determined in the determining unit 334 that the feature quantity information, which approximately agrees with the extracted feature quantity information, is not stored, the image presence determining unit 336 determines whether an image of the measurement object 20 is in the periphery of the field of view. If it is determined in the image presence determining unit 336 that the image of the measurement object 20 is in the periphery of the field of view, the message outputting unit 337 displays and outputs a message to move the measurement object 20 so that the measurement object 20 is within the range of the field of view.

The displaying unit 331 displays epi-illumination image data, which is image data representing an epi-illumination image taken by the imaging apparatus 25 using the epi-illuminating system 22, and transmitted image data, which is image data representing a transmitted image taken by the imaging apparatus 26 using the transmission illuminating system 24, such that the centers of the fields of view of both the images are positioned approximately at the center of the screen of the display device 27. A high-magnification-side image and a low-magnification-side image are each displayed so that the center of the field of view is positioned approximately at the center of the screen of the display device 27.

The feature quantity information storing unit 332 stores feature quantity information on feature quantities inherent in the shape of an image acquired when a measurement operator normally places the measurement object 20 on the stage 21, in association with information on measurement conditions of the measurement object 20. In other words, by extracting a measurement object whose feature quantity information approximately agrees with that of an object to be measured, predetermined dimensions and the like can be immediately measured based on information on measurement conditions that is associated with the feature quantity information. The term “information on measurement conditions” as used herein is a broad concept including various setting parameters for lighting conditions, exposure time of an imaging device, and automatic measurement, in addition to a method of detecting edges of a measurement object, and specification of edges to be measured, and the like.

The feature quantity information extracting unit 333 extracts feature quantity information inherent in the shape of the image from an image that is obtained by imaging and is displayed. Specifically, extracted as feature quantity information are the area and the surrounding length of the obtained image, lengths of the long side and the short side of a minimum rectangle circumscribing the obtained image, the number of hole-like voids of the obtained image, the degree of agreement (e.g., the degree of roundness) between the obtained image and a circle having the same area, the distance from the center of gravity to the border line of the obtained image, and the like.

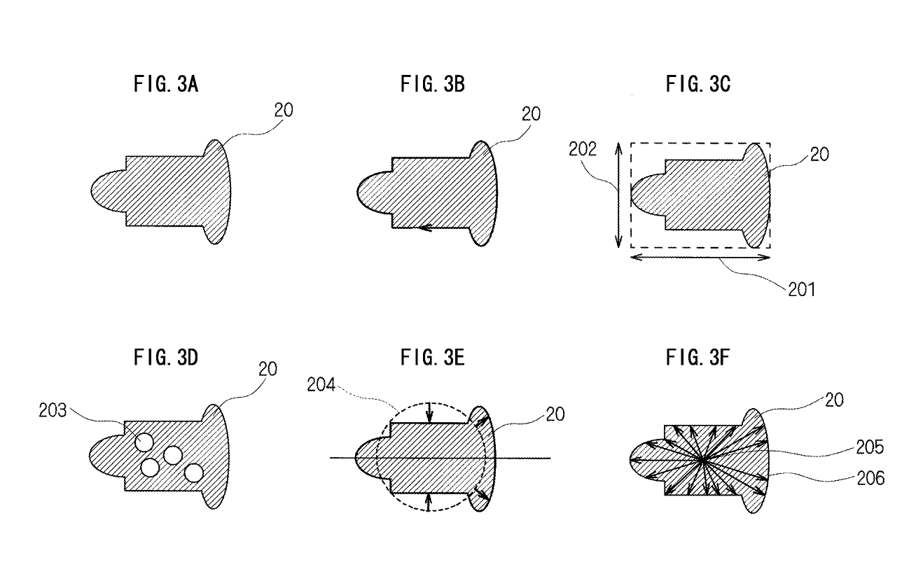

FIGS. 3A to 3F are schematic views showing kinds of feature quantity information according to the first embodiment. In FIG. 3A, the area of an image representing the measurement object 20 is calculated as feature quantity information. In FIG. 3B, the surrounding length of an image representing the measurement object 20 is calculated as feature quantity information. In FIG. 3C, a minimum rectangle circumscribing an image representing the measurement object 20 is determined, and the lengths of a long side 201 and a short side 202 of the rectangle are calculated as feature quantity information.

In FIG. 3D, if an image representing the measurement object 20 has a plurality of hole-like voids 203, the number of voids 203 is extracted as feature quantity information. In FIG. 3E, the degree of agreement between an image representing the measurement object 20 and a circle 204 having the same area is calculated as feature quantity information. In FIG. 3F, the distance from a center of gravity 205 to a border line 206 of an image representing the measurement object 20 is calculated as feature quantity information.

The determining unit 334 determines whether feature quantity information approximately in agreement with the extracted feature quantity information is stored in the storing device 34. Whether the extracted feature quantity information approximately agrees with the stored feature quantity information can be determined by whether a difference value between them is within a predetermined error range, in the case where feature quantity information is represented in a single numerical value as shown in FIGS. 3A, 3B, 3D and 3E. In the case where feature quantity information is represented in a plurality of numerical values as shown in FIGS. 3C and 3F, it can be determined by calculating how much the extracted feature quantity information agrees with the stored feature quantity information based on differences of the numerical values between them.

If it is determined in the measuring unit 335 that feature quantity information approximately in agreement with the extracted feature quantity information is stored in the storing device 34, then the shape of the measurement object 20 is measured based on information on measurement conditions stored in association with the feature quantity information. In other words, if both feature quantity information approximately agrees, it can be determined that the shapes of the measurement objects 20 in both cases approximately agree. Accordingly, measurement is performed by using information on measurement conditions corresponding to the shape. This enables measurement of a desired shape without specifying and detecting edges at each time of measurement. Note that the timing of measuring is not particularly limited. Measurement may be started at the timing of receiving a specification with a button, a switch, or the like. Measurement may also be automatically started at the timing at which information on measurement conditions is specified.

If it is determined in the determining unit 334 that feature quantity information approximately in agreement with the extracted feature quantity information is not stored in the storing device 34, then the image presence determining unit 336 determines whether an image of the measurement object 20 is in the periphery of the field of view. If the image of the measurement object 20 is determined to be in the periphery of the field of view, it can be determined that the measurement object 20 is mounted across the boundary of the field of view.

If it is determined in the image presence determining unit 336 that an image of the measurement object 20 is in the periphery of the field of view, then the message outputting unit 337 outputs and displays a message to move the measurement object 20 so that the measurement object 20 is within the range of the field of view. When a measurement operator properly mounts the measurement object 20, the measurement object 20 can be properly measured if feature quantity information approximately in agreement with that of the measurement object 20 is stored. In this manner, unnecessary recurring of the procedure can be prevented.

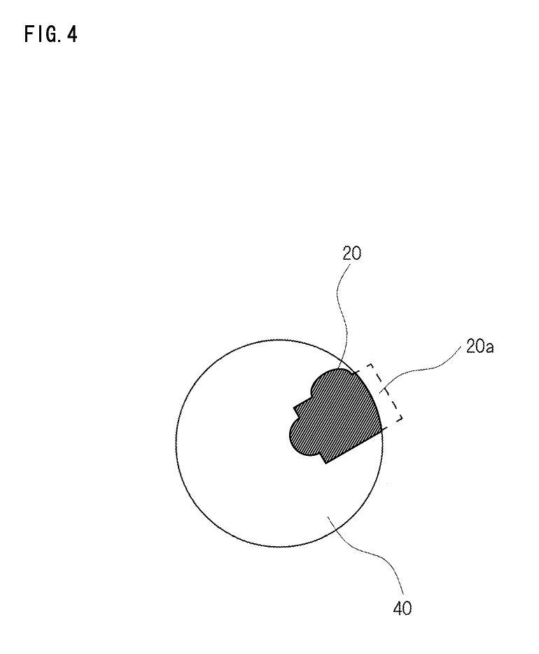

FIG. 4 shows an example of the state where an image of the measurement object 20 is placed across the boundary of the field of view. As shown in FIG. 4, in the case where the measurement object 20 is mounted at a position slightly away from the center of the stage 21, a region 20a protruding from the field of view 40 might be created. In this case, since feature quantity information is extracted based on an image of the measurement object 20 in the range of the field of view 40, the feature quantity information is erroneously determined not to be in agreement with the stored feature quantity information even though both the feature quantity information is relevant to the same measurement object 20.

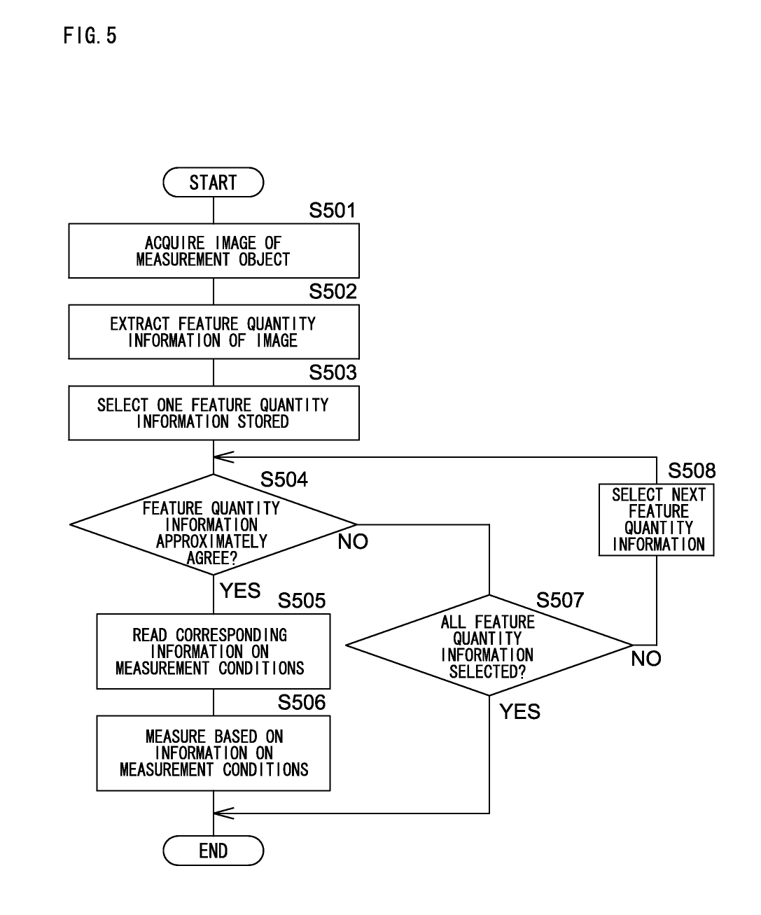

Hereinafter, an operation of the image measuring apparatus 1 according to the first embodiment of the present invention with the above-described configuration will be described in detail with reference to the flow charts. FIG. 5 is a flow chart showing a procedure of a comparison process of feature quantity information of the CPU 33 of the control unit 3 of the image measuring apparatus 1 according to the first embodiment of the present invention.

As shown in FIG. 5, the CPU 33 of the control unit 3 acquires an image obtained by imaging the measurement object 20 (step S501), and extracts feature quantity information based on the acquired image (step S502). The CPU 33 selects one feature quantity information that has been stored in the storing device 34 (step S503) and determines whether the extracted feature quantity information approximately agrees with the selected feature quantity information (step S504). Note that when feature quantity information is numerical information, approximate agreement between extracted feature quantity information and stored feature quantity information may be determined by whether their numerical values including appropriate calculation errors are each within a predetermined range.

If it is determined by the CPU 33 that the extracted feature quantity information and the selected feature quantity information approximately agree (step S504: YES), then the CPU 33 reads information on measurement conditions stored in association with the selected feature quantity information, which approximately agrees with the extracted feature quantity information (step S505), and measures the shape of the measurement object 20 based on the read information on measurement conditions (step S506). If it is determined by the CPU 33 that the extracted feature quantity information and the selected feature quantity information do not agree (step S504: NO), then the CPU 33 determines whether all feature quantity information has been selected (step S507).

If it is determined by the CPU 33 that there is feature quantity information that has not been selected (step S507: NO), then the CPU 33 selects the next feature quantity information (step S508) and returns the process to step S504, so that the above-mentioned process is repeated. If it is determined by the CPU 33 that all feature quantity information has been selected (step S507: YES), then the CPU 33 finishes the process.

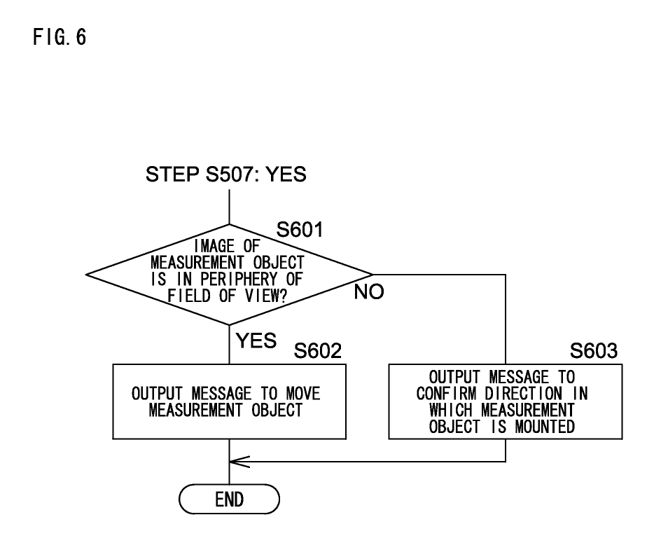

In the case where the extracted feature quantity information is compared to all stored feature quantity information, if it is determined that no feature quantity information approximately in agreement with the extracted feature quantity information is stored, there is a possibility that the measurement object 20 is not properly mounted. FIG. 6 is a flow chart showing a procedure of a subsequent process of the CPU 33 of the control unit 3 of the image measuring apparatus 1 according to the first embodiment of the present invention, in the case where no feature quantity information that approximately agrees with the extracted feature quantity information is stored.

If it is determined by the CPU 33 of the control unit 3 that all feature quantity information has been selected (step S507: YES), then the CPU 33 determines whether an image representing the measurement object 20 is in the periphery of the field of view (step S601). If it is determined by the CPU 33 that the image representing the measurement object 20 is in the periphery of the field of view (step S601: YES), then the CPU 33 determines that the measurement object 20 is mounted to be deviated from the center part of the field of view, and outputs to the display device 27 a message to move the measurement object 20 toward the center part of the field of view (step S602) to prompt a measurement operator to move the measurement object 20.

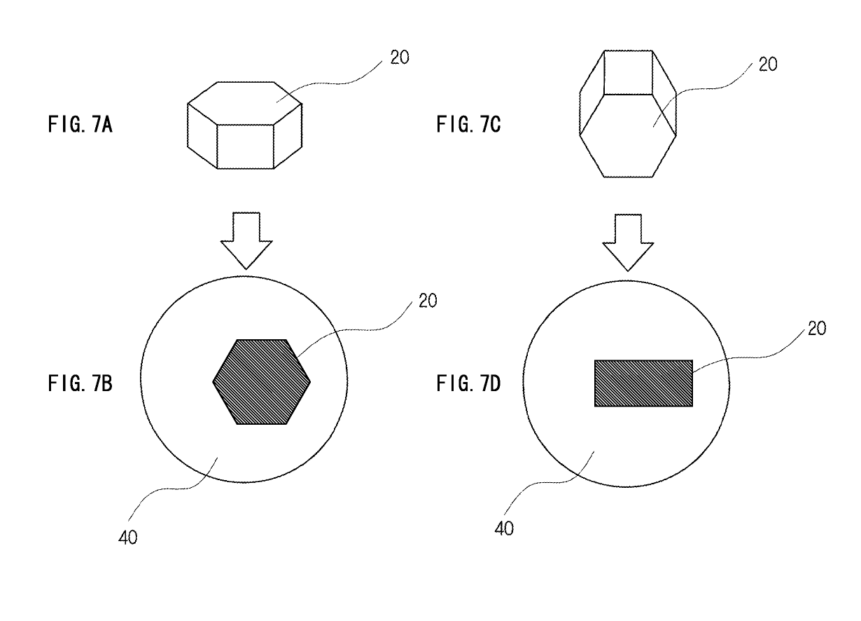

If it is determined by the CPU 33 that the image representing the measurement object 20 is not in the periphery of the field of view (step S601: NO), then the CPU 33 determines that the position at which the measurement object 20 is mounted is appropriate and outputs to the display device 27 a message to confirm the direction in which the measurement object 20 is mounted (step S603) to prompt a measurement operator to confirm whether the measurement object 20 is properly mounted. FIGS. 7A to 7D are views showing examples of false calculation of agreement caused by a difference in direction in which the measurement object 20 is mounted.

When the measurement object 20 is a hexagonal prism as shown in FIG. 7A, the measurement object 20 is generally mounted such that a bottom surface thereof, which is a hexagon, is on the top surface of the stage 21. Accordingly, an image of the measurement object 20 is a hexagon as shown in FIG. 7B. Therefore, approximate agreement is determined by extracting, for example, the area of the image representing the hexagon.

On the other hand, if a measurement operator mounts the measurement object 20 by mistake such that a side surface of the hexagonal prism is on the top surface of the stage 21 as shown in FIG. 7C, the image of the measurement object 20 is a quadrilateral as shown in FIG. 7D. Therefore, for example, even if the area of the image representing a hexagon is extracted as feature quantity information, the area is erroneously determined not to be in agreement with the area of a quadrilateral. It is therefore important to confirm whether the measurement object 20 is properly mounted on the stage 21.

As described above, according to the first embodiment, the shape of a measurement object is measured based on information on measurement conditions associated with stored feature quantity information that approximately agrees with feature quantity information extracted from an image of the measurement object. The feature quantity information is inherent in the shape of the image. This measurement does not involve a pattern matching process between images that imposes a large load of computing. Thus, the load of computing in measurement can be greatly reduced.

Moreover, determination is made as to whether an image of the measurement object 20 is in the periphery of the field of view. If it is determined that the image is in the periphery, the measurement object 20 can be considered to be mounted protruding from the field of view. Accordingly, by outputting a message notifying that effect, a measurement operator can be prompted to mount the measurement object again in a proper way. Therefore, it is possible to measure the shape of the measurement object efficiently without recurring of the procedure, and the like.

Further, if it is determined that an image of the measurement object 20 is not in the periphery of the field of view, the measurement object 20 is not mounted protruding from the field of view. Possibilities of human errors that a measurement operator mounted the measurement object 20 by mistake, and that the measurement object 20 is not mounted in a direction along which it should be mounted can be considered. Therefore, by outputting a message notifying that effect, a measurement operator can be prompted to mount the proper measurement object again in a proper way. Therefore, it is possible to measure the shape of the measurement object efficiently without recurring of the procedure, and the like.

Note that in the first embodiment described above, if it is determined that an image representing the measurement object 20 is not in the periphery of the field of view, the process is continued assuming that the measurement object 20 is not properly mounted. However, the present invention is not limited thereto. For example, if a determination of disagreement is erroneously made by chance because of an unexpected fault, it is only necessary to output a message representing that a measurement has failed.

### Second Embodiment

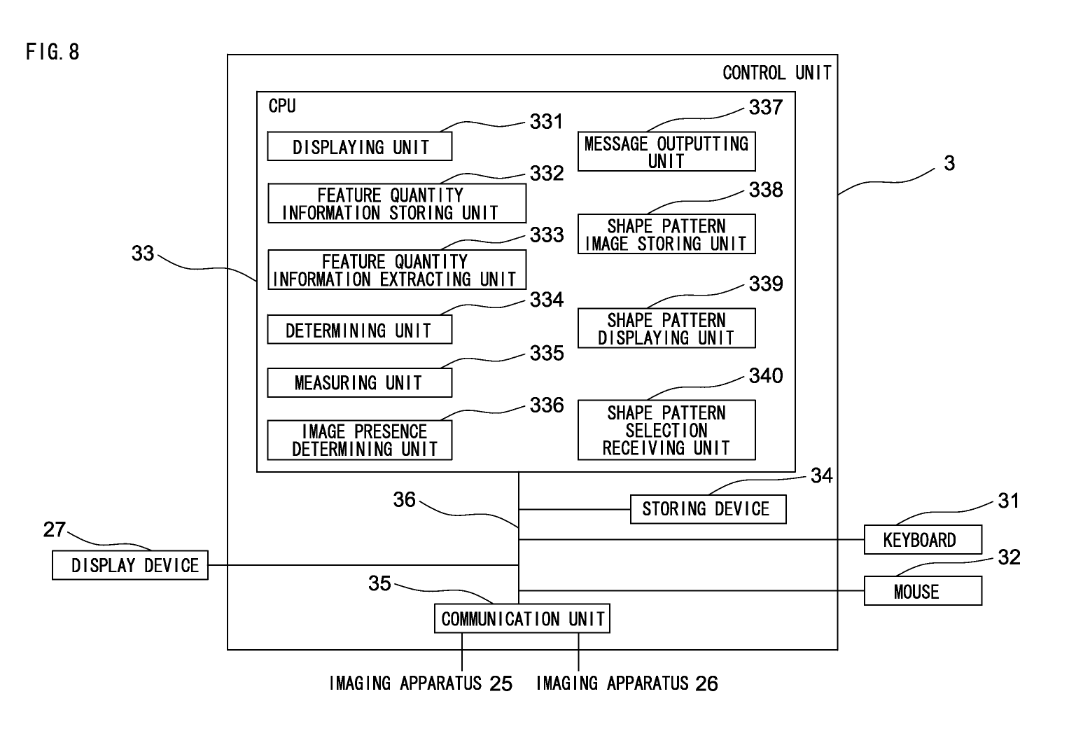

The configuration of the image measuring apparatus 1 according to a second embodiment of the present invention is the same as that of the first embodiment, and therefore the components are denoted by the same reference numerals and the detailed description thereof will not be given. FIG. 8 is a block diagram showing the configuration of the control unit 3 of the image measuring apparatus 1 according to the second embodiment of the present invention. The hardware configuration of the control unit 3 of the image measuring apparatus 1 according to the second embodiment is the same as that of the first embodiment, as shown in FIG. 8, and therefore the same components are denoted by the same reference numerals and the detailed description thereof will not be given.

In the second embodiment, the CPU 33 of the control unit 3 functions as a shape pattern image storing unit 338 to store, in the storing device 34, shape pattern image data of a measurement object that is associated with information on measurement conditions of the measurement object. The shape pattern image storing unit 338 also stores feature quantity information inherent in a measurement object, such as the area, the surrounding length, and the distance from the center of gravity to the border line of the obtained image, which are stored in the feature quantity information storing unit 332, in an association manner. The CPU 33 of the control unit 3 differs from that in the first embodiment in that if it is determined in the determining unit 334 that a plurality of pieces of feature quantity information approximately in agreement with the extracted feature quantity information are stored, the CPU 33 functions as a shape pattern displaying unit 339 for displaying shape pattern image data each corresponding to each feature quantity information, and as a shape pattern selection receiving unit 340 for receiving selection of one shape pattern image data from the plurality of pieces of displayed shape pattern image data.

The shape pattern displaying unit 339 displays the plurality of pieces of shape pattern image data corresponding to the plurality of pieces of stored feature quantity information, for example, as thumbnail images on the display device 27. The method of specifying the order of listing the thumbnail images is not particularly limited. The thumbnail images may be listed by sorting in various ways, such as in decreasing (increasing) order of calculated degree of agreement, in increasing (decreasing) date order in which the images are selected, in increasing (decreasing) date order in which the images are created as feature quantity information (information on measurement conditions). The shape pattern selection receiving unit 340 receives selection of shape pattern image data considered to be the closest to the measurement object from the listed shape pattern image data by using a mouse, button or the like.

Note that, in the above-described embodiment, if approximate agreement is determined in the determining unit 334, the shape pattern displaying unit 339 that displays a shape pattern corresponding to each of a plurality of pieces of shape pattern image data for which approximate agreement is determined is used, but information representing each of the plurality of pieces of shape pattern image data for which approximate agreement is determined is not limited to the shape pattern. Various kinds of information, such as a part name with which an operator can recognize each shape pattern, and a file name and a comment for an image data file that are set by an operator when registering the shape pattern image data, may be used.

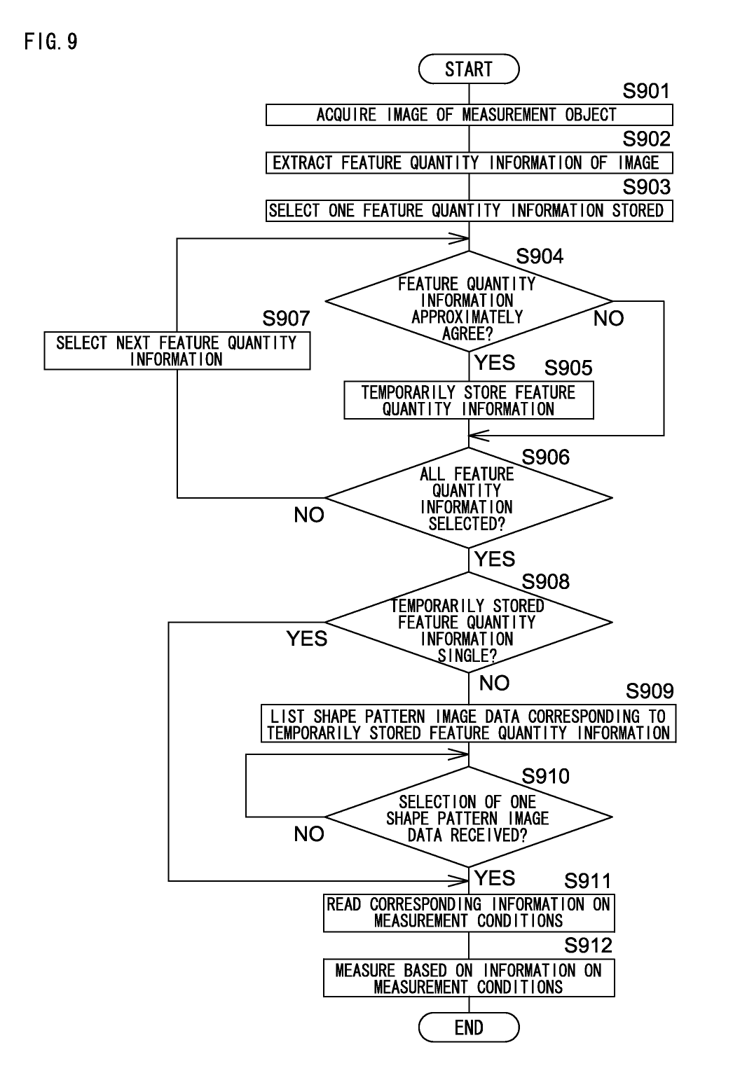

For the operation of the image measuring apparatus 1 according to the second embodiment of the present invention with the above configuration, detailed description will be given with reference to a flow chart. FIG. 9 is a flow chart showing a procedure of a comparison process of feature quantity information of the CPU 33 of the control unit 3 of the image measuring apparatus 1 according to the second embodiment of the present invention.

As shown in FIG. 9, the CPU 33 of the control unit 3 acquires an image of the measurement object 20 (step S901), and extracts feature quantity information based on the acquired image (step S902). The CPU 33 selects one feature quantity information stored in the storing device 34 (step S903) and determines whether the extracted feature quantity information approximately agrees with the selected feature quantity information (step S904). Note that when feature quantity information is numerical information, approximate agreement between extracted feature quantity information and stored feature quantity information may be determined by whether their numerical values including appropriate calculation errors are each within a predetermined range.

If it is determined by the CPU 33 that the extracted feature quantity information and the selected feature quantity information approximately agree (step S904: YES), then the CPU 33 temporarily stores the feature quantity information in the storing device (memory) 34 (step S905); if it is determined by the CPU 33 that the extracted feature quantity information and the selected feature quantity information do not agree (step S904: NO), then the CPU 33 skips to step S905.

The CPU 33 determines whether all feature quantity information has been selected (step S906). If it is determined by the CPU 33 that there is feature quantity information that has not been selected (step S906: NO), then the CPU 33 selects the next feature quantity information (step S907) and returns the process to step S904, so that the above-mentioned process is repeated. If it is determined by the CPU 33 that all feature quantity information has been selected (step S906: YES), then the CPU 33 determines whether feature quantity information temporarily stored in the storing device (memory) 34 is single (one) (step S908).

If it is determined by the CPU 33 that a plurality of pieces of feature quantity information are temporarily stored (step S908: NO), then the CPU 33 reads a plurality of pieces of shape pattern image data corresponding to the plurality of pieces of feature quantity information temporarily stored and lists them on the display device 27 (step S909). The CPU 33 determines whether selection of one shape pattern image data from the plurality of pieces of listed shape pattern image data is received (step S910). If it is determined by the CPU 33 that selection of one shape pattern image data is not received (step S910: NO), then the CPU 33 becomes a selection waiting state.

If it is determined by the CPU 33 that selection of one shape pattern image data is received (step S910: YES) or that the temporarily stored feature quantity information is single (step S908: YES), then the CPU 33 reads information on measurement conditions stored in association with the received shape pattern image data (step S911) and measures the shape of the measurement object based on the read information on measurement conditions (step S912).

For the case where it is determined that no feature quantity information that approximately agrees with the extracted feature quantity information is stored, even when the extracted feature quantity information is compared to all stored feature quantity information, the subsequent process is the same as in the first embodiment. Therefore, detailed description thereof will not be given.

As described above, according to the second embodiment, even if a plurality of pieces of feature quantity information are stored as candidates for selection of information on measurement conditions, it is possible to uniquely specify information on measurement conditions by receiving selection of one shape pattern image data from a plurality of pieces of corresponding shape pattern image data.

If the candidates have been narrowed down to a plurality of pieces of feature quantity information in the second embodiment described above, using a plurality of pieces of shape pattern image data stored in association with feature quantity information, a pattern matching process may be performed between the plurality of pieces of shape pattern image data and image data representing the acquired image of the measurement object, so that the shape is measured based on shape pattern image data with the highest degree of agreement. Since the plurality of pieces of shape pattern image data are narrowed down to several pieces of shape pattern image data to which the pattern matching process is applied, an increased load of computer processing caused by performing a pattern matching process can be limited to the minimum.

### Third Embodiment

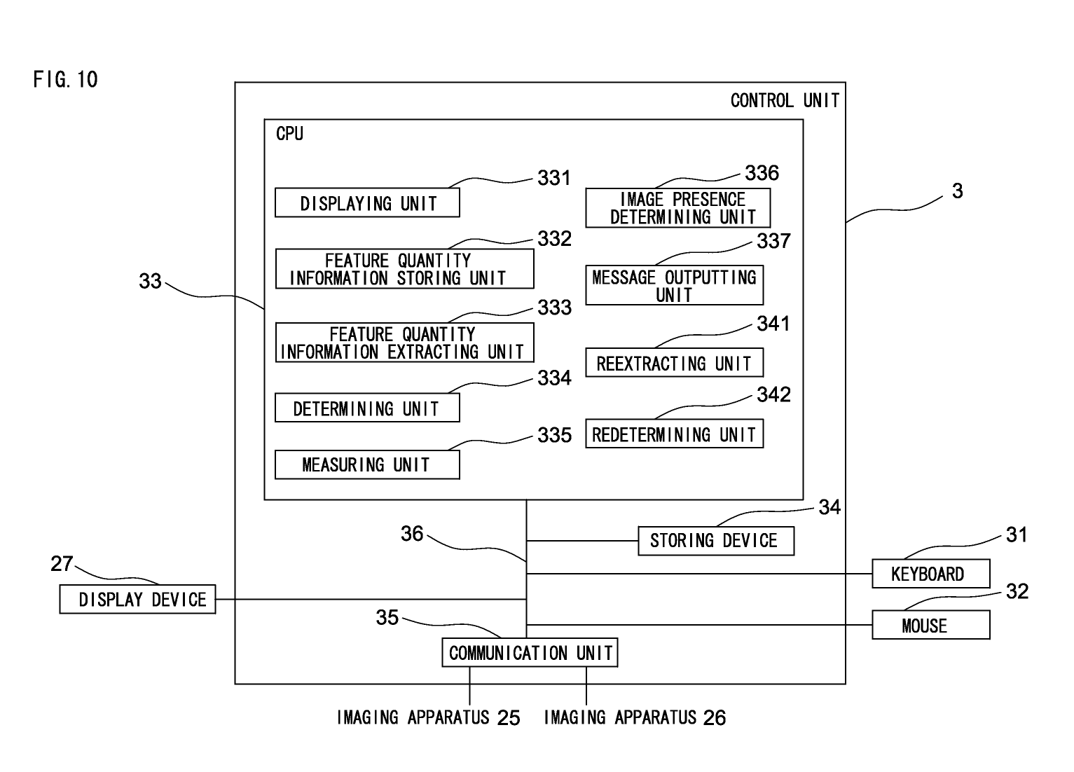

The configuration of the image measuring apparatus 1 according to a third embodiment of the present invention is the same as those of the first and second embodiment, and therefore the components are denoted by the same reference numerals and the detailed description thereof will not be given. FIG. 10 is a block diagram showing the configuration of the control unit 3 of the image measuring apparatus 1 according to the third embodiment of the present invention. The hardware configuration of the control unit 3 of the image measuring apparatus 1 according to the third embodiment is the same as that of the first embodiment as shown in FIG. 10, and therefore the same components are denoted by the same reference numerals and the detailed description thereof will not be given.

In the third embodiment, the CPU 33 of the control unit 3 differs from those in the first and second embodiments in that if it is determined in the determining unit 334 that a plurality of pieces of feature quantity information that approximately agree with feature quantity information extracted from an image are stored, then the CPU 33 functions as a reextracting unit 341 that extracts another feature quantity information based on the acquired image, and as a redetermining unit 342 that determines whether feature quantity information that approximately agrees with the extracted another feature quantity information is stored in the storing device 34.

The reextracting unit 341 extracts, from the image that is obtained by imaging and is displayed, another feature quantity information that is also inherent in the shape of the image and that is different from the feature quantity information serving as a base for the previous determination as to whether feature quantity information approximately in agreement with the extracted feature quantity information is stored. For example, if whether feature quantity information approximately in agreement with the extracted feature quantity information is stored is determined previously based on the area of the image obtained by imaging, the surrounding length of the image is extracted as another feature quantity information.

For information on measurement conditions corresponding to the plurality of pieces of stored feature quantity information, the redetermining unit 342 determines whether feature quantity information that approximately agrees with the extracted another feature quantity information is stored in the storing device 34. Determination of whether the extracted feature quantity information and the stored feature quantity information approximately agree is the same as in the first and second embodiments.

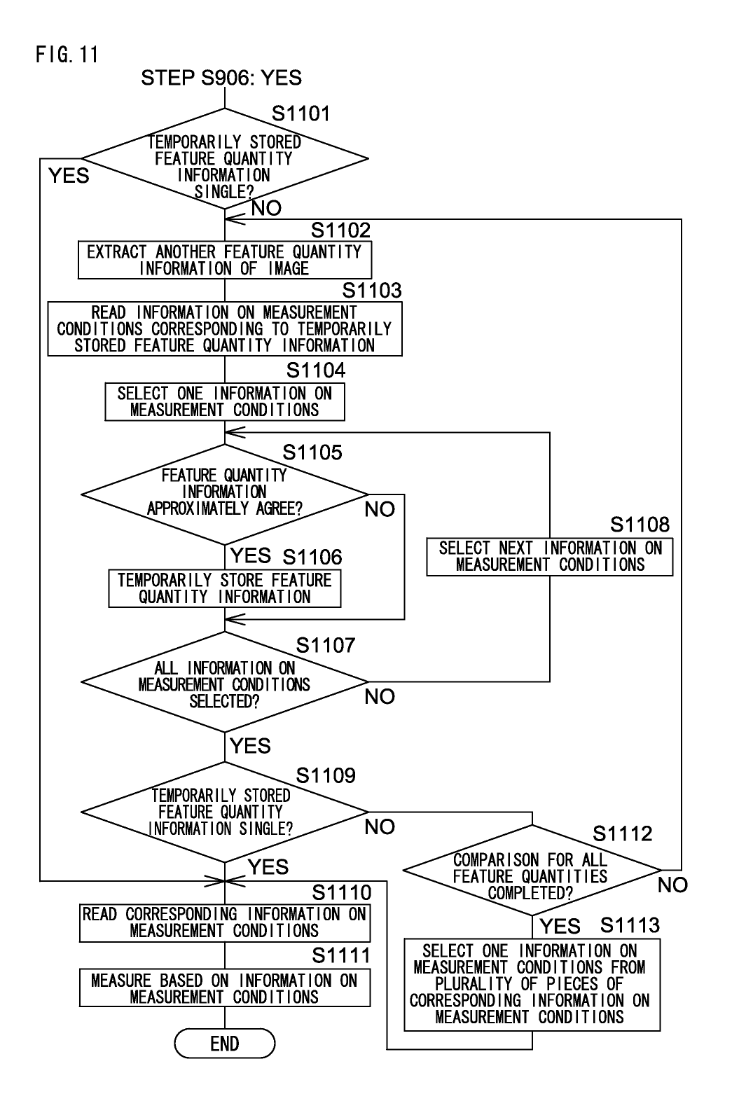

For the operation of the image measuring apparatus 1 according to the third embodiment of the present invention with the above configuration, detailed description will be given with reference to a flow chart. FIG. 11 is a flow chart showing a procedure of a comparison process of feature quantity information of the CPU 33 of the control unit 3 of the image measuring apparatus 1 according to the third embodiment of the present invention. As shown in FIG. 11, the process from the step in which the CPU 33 of the control unit 3 acquires an image of the measurement object 20 (step S901) to the step in which the CPU 33 determines whether all feature quantity information has been selected (step S906) is the same as that in the second embodiment as shown in FIG. 9, and therefore the detailed description thereof will not be given.

If it is determined by the CPU 33 that all feature quantity information has been selected (step S906: YES), the CPU 33 determines whether feature quantity information temporarily stored in the storing device (memory) 34 is single (one) (step S1101). If it is determined by the CPU 33 that the temporarily stored feature quantity information is single (one) (step S1101: YES), then the CPU3 skips over the process from step S1102 to step S1109, which will be described later.

If it is determined by the CPU 33 that a plurality of pieces of feature quantity information are temporarily stored (step S1101: NO), then the CPU 33 extracts another feature quantity information, which is different from the previous feature quantity information, based on the acquired image (step S1102). The CPU 33 reads a plurality of pieces of information on measurement conditions corresponding to the plurality of pieces of feature quantity information based on the previously used feature quantity information, which are temporarily stored in the storing device 34 (step S1103), selects one piece of information on measurement conditions from the plurality of pieces of read information on measurement conditions (step S1104), and redetermines whether the extracted another feature quantity information and feature quantity information stored in association with the selected information on measurement conditions approximately agree (step S1105). Note that when feature quantity information is numerical information, approximate agreement between extracted feature quantity information and stored feature quantity information may be determined by whether their numerical values including appropriate calculation errors are each within a predetermined range.

If it is determined by the CPU 33 that the extracted another feature quantity information and the feature quantity information stored in association with the selected information on measurement conditions approximately agree (step S1105: YES), then the CPU 33 temporarily stores the feature quantity information again in the storing device 34 (step S1106). If it is determined by the CPU 33 that the extracted another feature quantity information and the feature quantity information stored in association with the selected information on measurement conditions do not approximately agree (step S1105: NO), then the CPU 33 skips over step S1106, and determines whether all information on measurement conditions temporarily stored has been selected (step S1107).

If it is determined by the CPU 33 that there is information on measurement conditions that has not been selected (step S1107: NO), then the CPU 33 selects the next information on measurement conditions (step S1108) and returns the process to step S904, so that the above-mentioned process is repeated. If it is determined by the CPU 33 that all the information on measurement conditions has been selected (step S1107: YES), then the CPU 33 determines whether the feature quantity information temporarily stored in the storing (memory) device 34 is single (one) (step

If it is determined by the CPU 33 that the temporarily stored feature quantity information is single (one) (step S1109: YES), then the CPU 33 reads information on measurement conditions stored in association with the feature quantity information (step S1110), and measures the shape of the measurement object 20 based on the read information on measurement conditions (step S1111). If it is determined by the CPU 33 that a plurality of pieces of feature quantity information are temporarily stored (step S1109: NO), then the CPU 33 determines whether a comparison process has been completed for all feature quantities (step S1112). If it is determined by the CPU 33 that there is a feature quantity that has not been completed (step S1112: NO), then the CPU 33 returns the process to step S1102, so that the above-mentioned process is repeated. If it is determined by the CPU 33 that the comparison process has been completed for all the feature quantities (step S1112: YES), then the CPU 33 receives one piece of information on measurement conditions from the plurality of pieces of corresponding information on measurement conditions (step S1113) and returns the process to step S1110.

For the case where it is determined that no feature quantity information approximately in agreement with the extracted feature quantity information is stored even when the extracted feature quantity information is compared to all feature quantity information stored in association with information on measurement conditions, the subsequent process is the same as in the first embodiment. Therefore, detailed description thereof will not be given.

As described above, according to the third embodiment, even if a plurality of pieces of feature quantity information remain as candidates, it is possible to uniquely specify feature quantity information corresponding to information on measurement conditions by selecting feature quantity information one by one and repeatedly continuing the comparison process until one feature quantity information remains as the final candidate.

The feature quantity information as the candidates is narrowed down by sequentially selecting another feature quantity information in the third embodiment described above. However, instead of sequentially selecting, a plurality of pieces of feature quantity information may be extracted from the image at the beginning, and a comparison process be simultaneously performed to select overlapping information on measurement conditions. The degree of agreement may also be calculated for each feature quantity information, and then the calculated degrees be summed up and feature quantity information having the highest degree of agreement be selected.

In the third embodiment described above, if the candidates are narrowed down to a plurality of pieces of feature quantity information, a pattern matching process may be performed at a stage where the candidates are narrowed down to several pieces of feature quantity information, without narrowing down the candidates to one feature quantity information. In other words, if the candidates are narrowed down to a plurality of pieces of feature quantity information, shape pattern image data stored in association with the feature quantity information may be used, a pattern matching process be performed between the data and image data representing the acquired image of the measurement object, and then the shape be measured based on the shape pattern image data with the highest degree of agreement. Since the shape pattern image data to which the pattern matching process is applied is narrowed down to several pieces, an increased load of computing caused by performing a pattern matching process can be limited to the minimum.

It should be understood that the present invention is not limited to the above-described first to three embodiments, and various modifications, replacements and the like may be made within the scope of the spirit of the present invention. For example, information on measurement conditions may be stored such that a plurality of information on measurement conditions is associated with one feature quantity information. Further, feature quantity information is not limited to the value disclosed herein and is not particularly limited as long as its value allows a comparison process to be performed at high speeds, like histogram values.

What is claimed is:

1. An image measuring apparatus for measuring a shape of a measurement object based on an image obtained by applying light onto a stage having the measurement object placed thereon and performing image formation of transmitted light or reflected light of the light on an imaging device, the image measuring apparatus comprising:
a feature quantity information storing unit configured to store feature quantity information inherent in the shape of the measurement object in association with information on measurement conditions of the measurement object;
a displaying unit configured to display, within a range of a field of view, the image of the measurement object obtained by performing image formation on the imaging device;
a feature quantity information extracting unit configured to extract feature quantity information based on the image of the measurement object;
a determining unit configured to determine whether feature quantity information approximately in agreement with the extracted feature quantity information is stored; and
a measuring unit configured to measure the shape of the measurement object if it is determined in the determining unit that the feature quantity information approximately in agreement is stored, based on the information on the measurement conditions stored in association with the feature quantity information.

2. The image measuring apparatus according to claim 1, further comprising:
an image presence determining unit configured to determine whether the image of the measurement object is in a periphery of the field of view, if it is determined in the determining unit that the feature quantity information approximately in agreement is not stored; and
a message outputting unit configured to output and display a message to move the measurement object so that the measurement object is within the range of the field of view, if it is determined in the image presence determining unit that the image of the measurement object is in the periphery of the field of view.

3. The image measuring apparatus according to claim 2, wherein the message outputting unit is configured to output and display a message to confirm a direction in which the measurement object is mounted, if it is determined in the image presence determining unit that the image of the measurement object is not in the periphery of the field of view.

4. The image measuring apparatus according to claim 1, further comprising:
a shape pattern image storing unit configured to store shape pattern image data of the measurement object in association with the information on the measurement conditions of the measurement object;
a displaying unit configured to display, if it is determined in the determining unit that a plurality of pieces of the feature quantity information approximately in agreement are stored, information corresponding to a plurality of pieces of corresponding shape pattern image data; and
a selection receiving unit configured to receive selection of information corresponding to one piece of shape pattern image data from the information corresponding to the plurality of pieces of displayed shape pattern image data.

5. The image measuring apparatus according to claim 1, further comprising:
a reextracting unit configured to extract another feature quantity information if it is determined in the determining unit that a plurality of pieces of the feature quantity information approximately in agreement are stored, based on the same image of the measurement object; and
a redetermining unit configured to determine, for information on measurement conditions corresponding to the plurality of pieces of the stored feature quantity information, whether feature quantity information approximately in agreement with the another feature quantity information extracted by the reextracting unit is stored; and
wherein the measuring unit is configured to measure the shape of the measurement object if it is determined in the redetermining unit that the feature quantity information approximately in agreement with the another feature quantity information is stored, based on the information on the measurement conditions stored in association with the feature quantity information.

6. A computer program executable with an image measuring apparatus for measuring a shape of a measurement object based on an image obtained by applying light onto a stage having the measurement object placed thereon and performing image formation of transmitted light or reflected light of the light on an imaging device, the computer program causing a computer to realize a function of the image measuring apparatus, the image measuring apparatus comprising:
a feature quantity information storing unit configured to store feature quantity information inherent in the shape of the measurement object in association with information on measurement conditions of the measurement object;
a displaying unit configured to display, within a range of a field of view, the image of the measurement object obtained by performing image formation on the imaging device;
a feature quantity information extracting unit configured to extract feature quantity information based on the image of the measurement object;
a determining unit configured to determine whether feature quantity information approximately in agreement with the extracted feature quantity information is stored; and
a measuring unit configured to measure the shape of the measurement object if it is determined in the determining unit that the feature quantity information approximately in agreement is stored, based on the information on the measurement conditions stored in association with the feature quantity information.

7. The computer program according to claim 6, the computer program causing the computer to realize the function of the image measuring apparatus, the image measuring apparatus further comprising:
an image presence determining unit configured to determine whether the image of the measurement object is in a periphery of the field of view, if it is determined in the determining unit that the feature quantity information approximately in agreement is not stored; and
a message outputting unit configured to output and display a message to move the measurement object so that the measurement object is within the range of the field of view, if it is determined in the image presence determining unit that the image of the measurement object is in the periphery of the field of view.

8. The computer program according to claim 7, the computer program causing the computer to realize the function of the image measuring apparatus, wherein the message outputting unit is configured to output and display a message to confirm a direction in which the measurement object is mounted, if it is determined in the image presence determining unit that the image of the measurement object is not in the periphery of the field of view.

9. The computer program according to claim 6, the computer program causing the computer to realize the function of the image measuring apparatus, the image measuring apparatus further comprising:
a shape pattern image storing unit configured to store shape pattern image data of the measurement object in association with the information on the measurement conditions of the measurement object;
a displaying unit configured to display, if it is determined in the determining unit that a plurality of pieces of the feature quantity information approximately in agreement are stored, information corresponding to a plurality of pieces of corresponding shape pattern image data; and
a selection receiving unit configured to receive selection of information corresponding to one piece of shape pattern image data from the information corresponding to the plurality of pieces of displayed shape pattern image data.

10. The computer program according to claim 6, the computer program causing the computer to realize the function of the image measuring apparatus, the image measuring apparatus further comprising:
a reextracting unit configured to extract another feature quantity information if it is determined in the determining unit that a plurality of pieces of the feature quantity information approximately in agreement are stored, based on the same image of the measurement object; and
a redetermining unit configured to determine, for information on measurement conditions corresponding to the plurality of pieces of the stored feature quantity information, whether feature quantity information approximately in agreement with the another feature quantity information extracted by the reextracting unit is stored; and
wherein the measuring unit is configured to measure the shape of the measurement object if it is determined in the redetermining unit that the feature quantity information approximately in agreement with the another feature quantity information is stored, based on the information on the measurement conditions stored in association with the feature quantity information.
